(19) United States
(12) Patent Application Publication
(10) Pub. No.: US 2013/0222417 A1
(43) Pub. Date: Aug. 29, 2013

(54) APPARATUS AND METHOD FOR SELECTIVELY DISPLAYING A SCREEN

(71) Applicant: Pantech Co., Ltd., (US)

(72) Inventors: Kyeong Hwan OK, Seoul (KR); Hyun Bae Kim, Seoul (KR); Mun Ok Cho, Seoul (KR)

(73) Assignee: Pantech Co., Ltd., Seoul (KR)

(21) Appl. No.: 13/748,975

(22) Filed: Jan. 24, 2013

(30) Foreign Application Priority Data
Feb. 24, 2012 (KR) 10-2012-0019234

(51) Int. Cl. G09G 5/37

(52) U.S. Cl. CPC G09G 5/37
USPC 345/619

(57) ABSTRACT

A terminal includes a display unit to display a plurality of layers associated with an application program, an analysis unit to determine a hierarchy of the layers, a determination unit to determine whether a specific layer is included in the layers, and a changing unit to change a tier of the specific layer in the hierarchy of layers from a first tier to a second tier. A method for selectively displaying a screen on a terminal includes displaying an application program screen including a plurality of layers, determining a hierarchy of the layers, determining whether a specific layer is included in the layers, and changing a tier of the specific layer in the hierarchy of layers from a first tier to a second tier.

### CROSS-REFERENCE TO RELATED APPLICATION

This application claims priority from and the benefit under 35 U.S.C. §119(a) of Korean Patent Application No. 10-2012-0019234, filed on Feb. 24, 2012, the entire disclosure of which is incorporated herein by reference for all purposes.

### BACKGROUND

1. Field

The following description relates to a display apparatus and method for selectively removing a display layer from view among multiple layers displayed on a screen of the display apparatus.

2. Discussion of the Background

Intelligent terminals to download, install and execute various applications over the Internet in a wired or a wireless environment, such as a tablet personal computer (PC) or a smart phone, have come into wide use. Such terminals may be provided with a predetermined interface screen to display information or process an event when the terminal operates or when an application in the terminal is executed.

Various applications have been developed to be used in such terminals. In particular, applications with built-in advertisement platform to display an advertisement when executing an application have been developed. By providing a free application downloading service at marketing costs of an advertiser, the advertisers may provide marketing effects to users using the free application. Because of availability of free applications, such applications have come into wide use.

When an application with a built-in advertisement platform is installed and executed in a terminal, as shown in FIG. 1, an application layer A to display application execution information and an advertisement layer B to display an advertisement provided by an advertisement server are both displayed on a screen of the terminal.

Accordingly, valuable real estate of the display screen may be allocated for information that may not be sought by the user. More specifically, the advertisement, which may be undesirable by a user, is displayed on the screen of the terminal whenever the advertisement platform built-in application is executed to provide some user inconvenience.

In order to alleviate user inconvenience associated with display of undesired advertisements in an application with the built in advertisement platform, a network advertisement blocking method for blocking an internet protocol (IP) or universal resource locator (URL) of an advertisement server has been introduced in order to block an advertisement on an application screen.

However, since the network advertisement block method of the related art blocks advertisement data provided by the advertisement server over a network but does not remove or hide the allocated advertisement display area, the advertisement display area allocated to load advertisement data or image, such as advertisement layer B, or an advertisement replacement image, which may be stored locally on the terminal, may be displayed on allocated display area of the screen of the terminal to occupy a screen region. Thus, the screen region of the terminal occupied by the advertisement layer B may be inefficiently used.

### SUMMARY

Exemplary embodiments of the present invention provide a display apparatus and method for selectively disabling a display layer among multiple layers displayed on a screen of the display apparatus.

Additional features of the invention will be set forth in the description which follows, and in part will be apparent from the description, or may be learned by practice of the invention.

Exemplary embodiments of the present invention provide a terminal including a display unit to display a plurality of layers associated with an application program; an analysis unit to determine a hierarchy of the layers; a determination unit to determine whether a specific layer is included in the layers; and a changing unit to change a tier of the specific layer in the hierarchy of layers from a first tier to a second tier.

Exemplary embodiments of the present invention provide a method for selectively displaying a screen on a terminal including displaying an application program screen including a plurality of layers; determining a hierarchy of the layers; determining whether a specific layer is included in the layers; and changing a tier of the specific layer in the hierarchy of layers from a first tier to a second tier.

Exemplary embodiments of the present invention provide a method for selectively displaying a screen on a terminal including displaying an application program screen comprising a plurality of layers; determining a hierarchy of the layers; determining whether a specific layer is included in the layers; and changing a tier of the specific layer to a reference tier to display the layers over the specific layer for hiding a display of the specific layer.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an application program screen displayed on a screen region of a general terminal.

FIG. 2 is a schematic block diagram illustrating a configuration of a screen display apparatus according to an exemplary embodiment of the present invention.

FIG. 3 is a diagram illustrating a hierarchy of an application program screen according to an exemplary embodiment of the present invention.

FIG. 4 is a schematic block diagram illustrating a configuration of a display unit of FIG. 2.

FIG. 5 is a schematic block diagram illustrating a configuration of a determination unit of FIG. 2.

FIG. 6 is a schematic block diagram illustrating a configuration of a changing unit of FIG. 2.

FIG. 7 is a flowchart illustrating a method for selectively displaying a screen according to an exemplary embodiment of the present invention.

FIG. 8 is a flowchart illustrating an operation of changing a hierarchy of FIG. 7.

FIG. 9, FIG. 10, FIG. 11, FIG. 12, and FIG. 13 are views of various layer configurations according to exemplary embodiments of the present invention.

FIG. 14 is a schematic block diagram illustrating a configuration of a changing unit according to an exemplary embodiment of the present invention.

FIG. 15 is a flowchart illustrating an operation of changing a hierarchy according to an exemplary embodiment of the present invention.

FIG. 16 is a view illustrating a layer configuration according to an exemplary embodiment of the present invention.

FIG. 17 and FIG. 18 are views illustrating various screen configurations according to exemplary embodiments of the present invention.

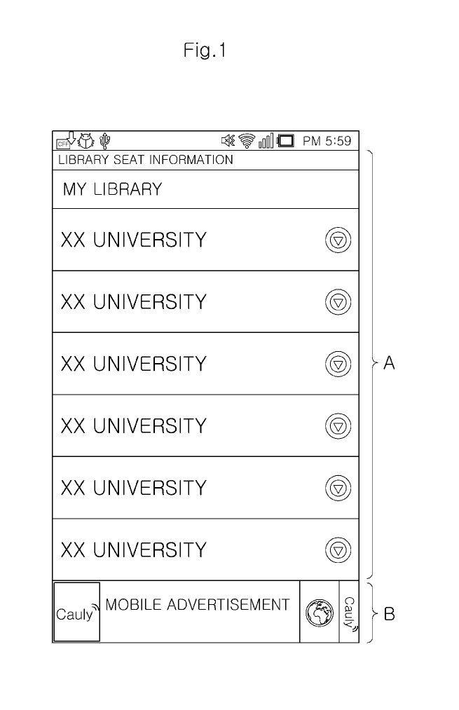

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

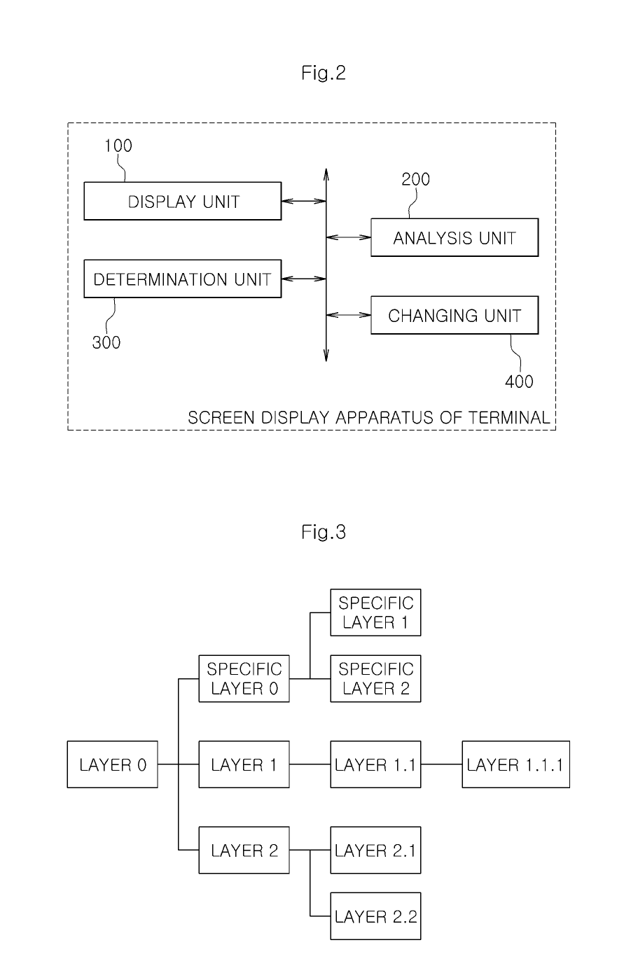

FIG. 2 is a schematic block diagram illustrating a configuration of a screen display apparatus according to an exemplary embodiment of the present invention.

Referring to FIG. 2, the screen display apparatus of a terminal includes a display unit 100, an analysis unit 200, a determination unit 300, and a changing unit 400. The analysis unit 200, the determination unit 300, and the changing unit 400 may be mounted and/or implemented in a controller of the terminal, which may control one or more operations of the terminal.

The display unit 100 may configure and display data of an application program. The display of the application program or application program screen may include one or more layers associated with an application program installed in the terminal.

The analysis unit 200 may analyze or determine a hierarchy of the application program screen or a general screen of the terminal.

The determination unit 300 may determine whether a specific layer is present in the layers configuring or included in the application program screen. For example, an application program screen may include layers that are designated to display application program data and/or graphics, and specific layers, which may be designated data and/or graphics associated with an advertisement.

The changing unit 400 may change the hierarchy of the application program screen such that a layer or layers associated with an advertisement, which may be referred to as specific layers, may not be displayed through the display unit 100.

The operations of the enumerated components will be described in more detail below.

FIG. 3 is a diagram illustrating a hierarchy of an application program screen according to an exemplary embodiment of the present invention.

Referring to FIG. 3, the layers configuring the application program screen may have a hierarchical relationship to provide a hierarchy of layers. The hierarchical relationship may be arranged as a tree structure or other hierarchy. The hierarchy may be provided according to the order of layers, such as tiers of layers, arranged on a screen, as shown in FIG. 3. One or more layers configuring or included in the application program screen may include, without limitation, at least one of identification information, arrangement order information, and attribute information. The attribute information may include a layout form (e.g., text, symbol, etc.) and a layout position of a layer with respect to a tier and/or location on a screen.

More specifically, LAYER 0 may provide a base image, on which LAYER 1, LAYER 2, and SPECIFIC LAYER 0 may be disposed thereupon. Similarly, SPECIFIC LAYER 1 and SPECIFIC LAYER 2 may be disposed on the SPECIFIC LAYER 0, and LAYER 2.1 and

LAYER 2.2 may be disposed on the LAYER 2. Further, LAYER 1.1, which may include LAYER 1.1.1 disposed thereon, may be disposed on LAYER 1. In an example, LAYER 0, LAYER 1, LAYER 1.1, LAYER 1.1.1, LAYER 2, LAYER 2.1, and LAYER 2.2 may be associated with an application program. SPECIFIC LAYER 0, SPECIFIC LAYER 1, and SPECIFIC LAYER 2 may be associated with an advertisement, messages from an advertiser, and the like.

The application program installed in the terminal may include a built-in advertisement platform and may be downloaded to the terminal over a network and installed in a memory region of the terminal. When a user inputs an execution command using a human machine interface (HMI) of the terminal, the application program installed in the terminal may be executed to provide layer information configuring the application program screen to the analysis unit 200 and the application program screen may be displayed on the display unit 100. The layer information may include, without limitation, at least one of identification information of the layer, information about an arrangement order of the layer in a hierarchy, and attribute information of the layer.

FIG. 4 is a schematic block diagram illustrating a configuration of a display unit of FIG. 2.

Referring to FIG. 4, the display unit 100 includes a loading module 110, a configuration module 120, and a display module 130. The loading module 110 may load layer information from an application program when the application program installed in the terminal is executed. The configuration module 120 may configure an application program screen when the application program is executed using the layer information loaded by the loading module 110. The display module 130 may display the application program screen configured by the configuration module 120. The display module 130 may include, for example, a display panel.

The analysis unit 200 may analyze a hierarchy of the application program screen.

The determination unit 300 may determine whether a specific layer is present in the layers configuring the application program screen. The specific layer may include an advertisement layer having a package or class name as identification information, but is not limited thereto.

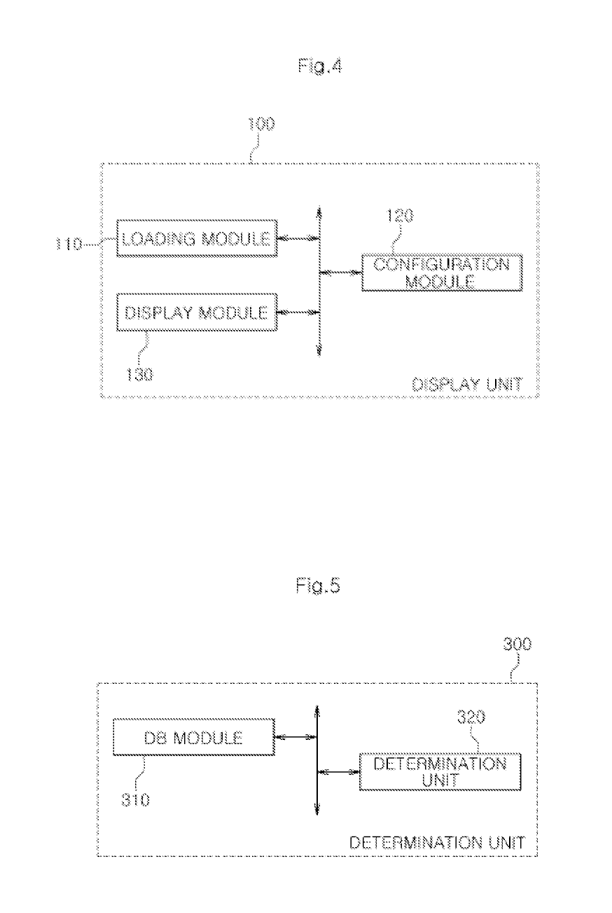

FIG. 5 is a schematic block diagram illustrating a configuration of a determination unit of FIG. 2.

Referring to FIG. 5, the determination unit 300 includes a database (DB) module 310 and a determination module 320. The DB module 310 may store identification information of the one or more layers, including the specific layer. The identification information of the specific layer stored in the DB module 310 may be updated by connecting the terminal to a network and communicating with a DB management server. The determination module 320 may determine that a layer including identification information matching the identification information of the specific layer stored in the DB module 310 as a specific layer.

The changing unit 400 may not change the hierarchy of the application program screen when the determination unit 300 determines that the specific layer is not present.

In addition, when the determination unit 300 determines that the specific layer is present, the changing unit 400 may change the hierarchy of the application program screen such that the specific layer may not be displayed through the display unit 100. Further, when the determination unit 300 determines that the specific layer is present, the changing unit 400 may remove the specific layer such that the specific layer may not be displayed through the display unit 100.

More specifically, the changing unit 400 may generate and arrange a new layer on a reference tier, such as a lowest tier, of the layer hierarchy, when the determination unit 300 determines that the specific layer is present. In an example, the lowest tier of the layer hierarchy may correspond to a tier including a layer on which some or all other layers may be disposed.

Thereafter, the changing unit 400 may change the arrangement order of the specific layer and arrange the specific layer on a reference tier in the hierarchy, which may be a tier lower than on which the new layer is disposed. In an example, the reference tier may refer to the lowest tier. Accordingly, layers associated with the application program along with the new layer may be disposed on and over the specific layer.

In addition, when an initial tier of the specific layer in the hierarchy of layers (i.e., a first tier) is changed to a different tier (i.e., a second tier) in the hierarchy, the changing unit 400 may select a valid layer, which may be disposed at the former tier of the specific layer (i.e., first tier), from among the layers configuring the hierarchy. Further, the changing unit 400 may change the attributes (e.g., an arrangement location on a screen, transparency, size or the like) and/or arrangement order (i.e., tier) of the selected valid layer, such that the valid layer is arranged at the former arrangement order or tier of the specific layer in the hierarchy before the arrangement order or tier of the specific layer was changed in the hierarchy (i.e., first tier).

The valid layer may correspond to a layer, which may be different from the specific layer and located at a different location (e.g., a third tier) before the arrangement order is changed but having the same arrangement order or tier as the specific layer before the arrangement order is changed. More specifically, the valid layer and the specific layer may be located at different arrangement locations within the same tier in the hierarchy before the specific layer is moved to a different tier. However, aspects of the invention are not limited thereto, such that the valid layer and the specific layer may be located at different tiers before the arrangement order or tier of the specific layer was changed.

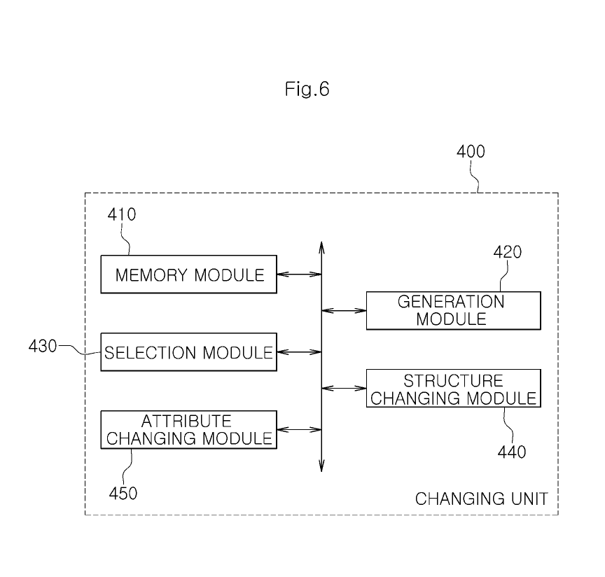

FIG. 6 is a schematic block diagram illustrating a configuration of a changing unit of FIG. 2.

Referring to FIG. 6, the changing unit 400 includes a memory module 410, a generation module 420, a selection module 430, a structure changing module 440 and an attribute changing module 450. The memory module 410 may store attributes of various layers including a new layer, which may occupy some portion or the entire display region of the display unit 100. The generation module 420 may generate a new layer using the attributes of the layers stored in the memory module 410. The selection module 430 may select a valid layer, which may be disposed at the former arrangement order or tier of the specific layer after arrangement order of the specific layer is changed, from among the layers configuring the application program screen. However, aspects of the invention are not limited thereto, such that the valid layer may replace the specific layer in part or in entirety. The structure changing module 440 may arrange the new layer generated by the generation module 420, change the arrangement order or tier of the specific layer and the valid layer selected by the selection module 430, and change the hierarchy of layers configuring the application program screen. The attribute changing module 450 may change the attributes of the valid layer selected by the selection module 430.

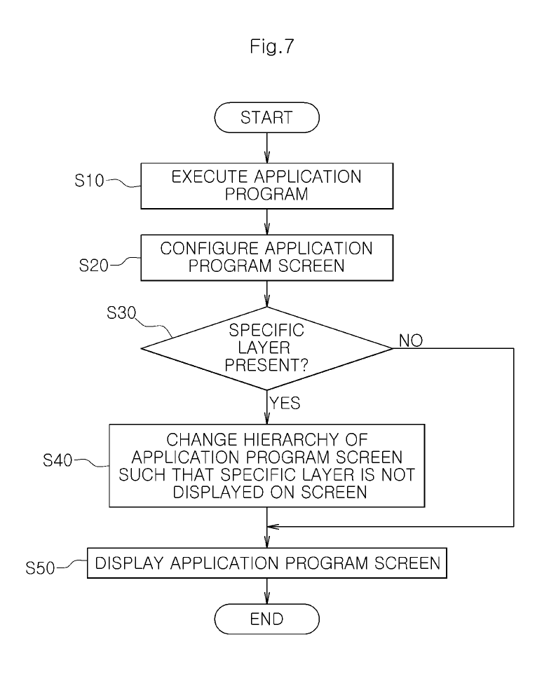

FIG. 7 is a flowchart illustrating a method for selectively displaying a screen according to an exemplary embodiment of the present invention.

In operation S10, an application program installed in a terminal is executed. In operation S20, the terminal configures the application program screen, which may include one or more layers associated with the application program. These layers may be disposed at different tiers and different locations in the application program screen.

In operation S30, the terminal determines whether a specific layer is present in the layers configuring the application program screen.

In operation S40, if it is determined that the specific layer is present in the layers configuring the application program screen, the hierarchy of layers configuring the application program screen is changed such that the specific layer is not displayed on the screen. Further, the specific layer may be removed such that the specific layer may not be displayed on the screen. More specifically, the specific layer may be moved to be located at a reference tier, which may be at the lowest tier on which other layers may be disposed, such that other layers overlap over the specific layer to block display of the specific layer. However, aspects of the invention are not limited thereto such that the specific layer may be replaced with another layer or deleted from view.

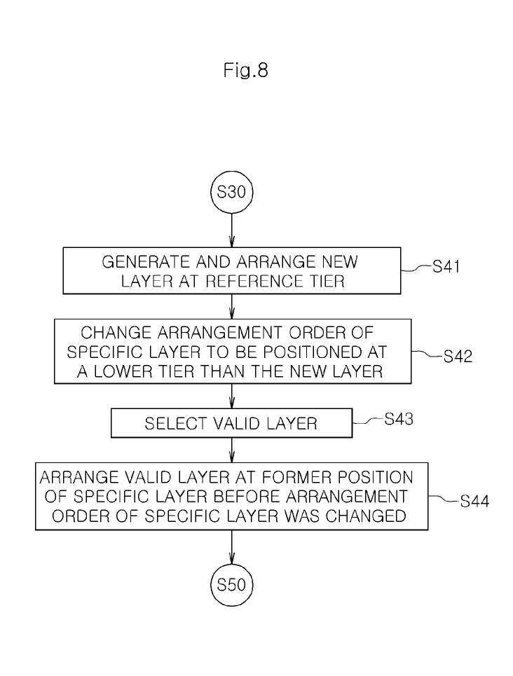

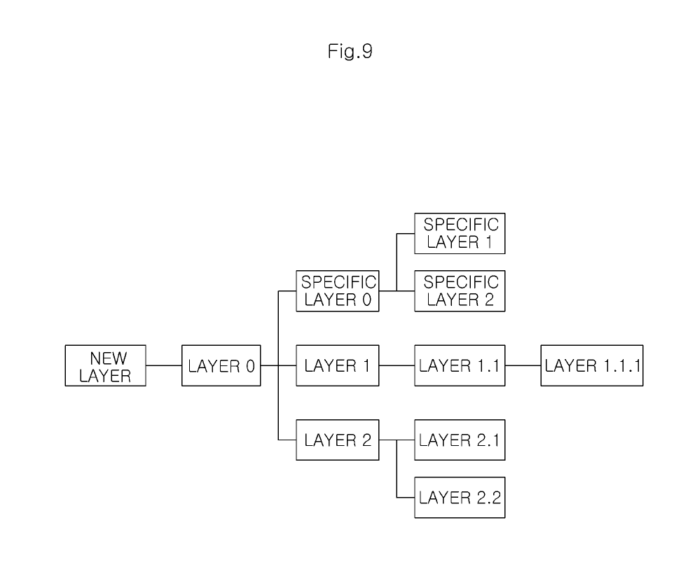

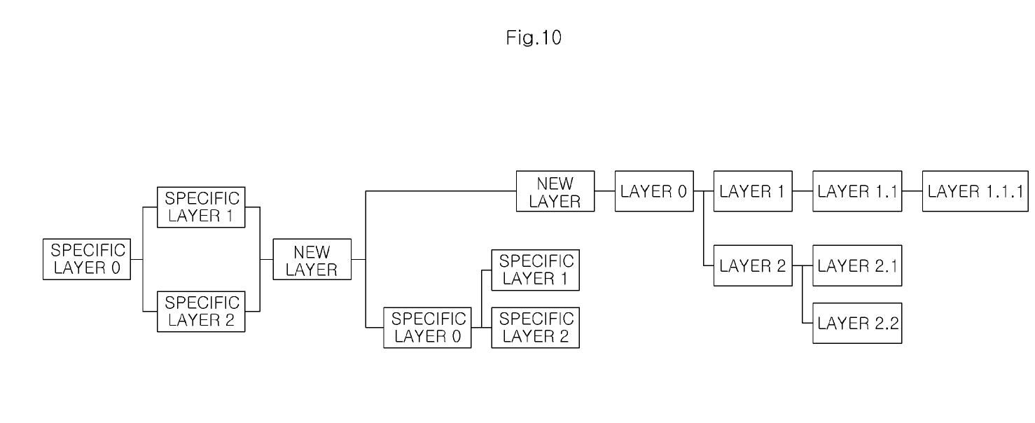

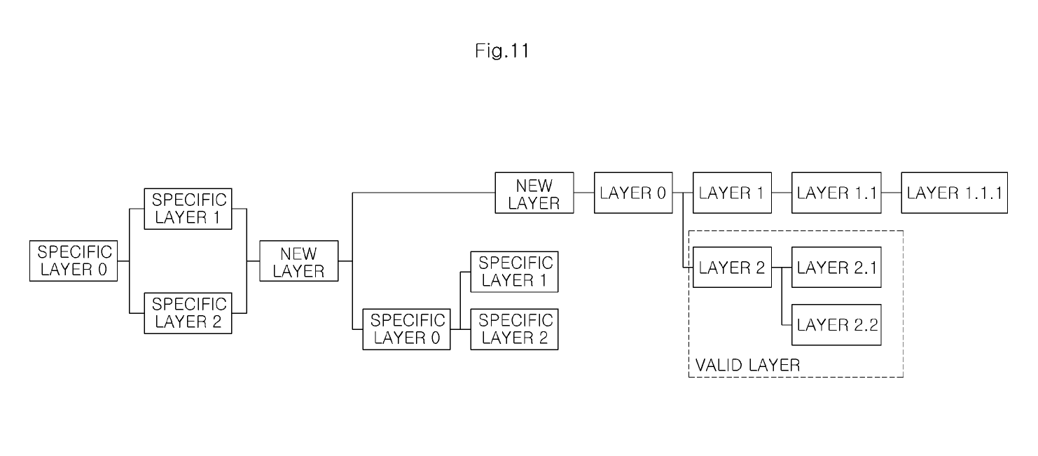

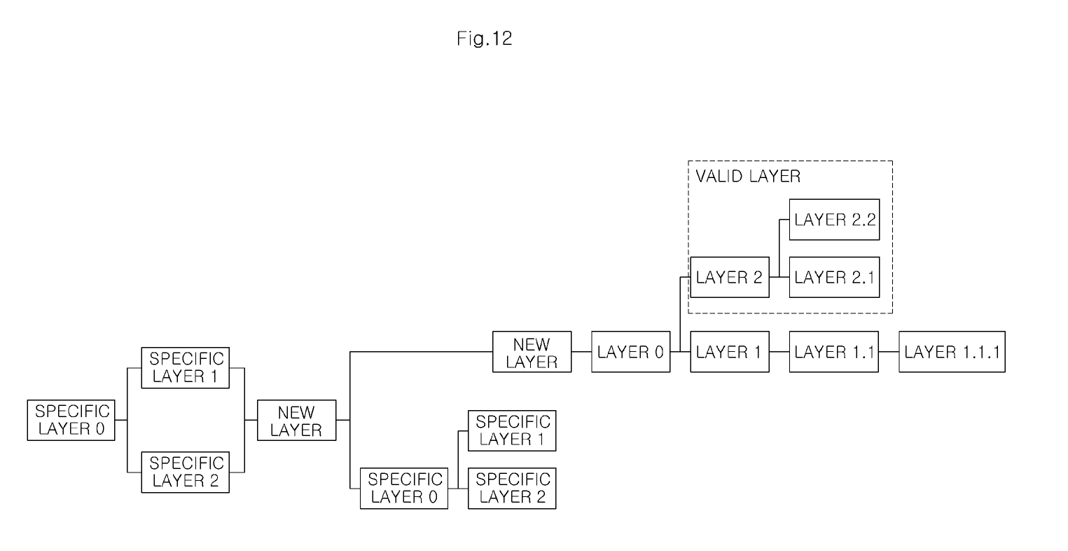

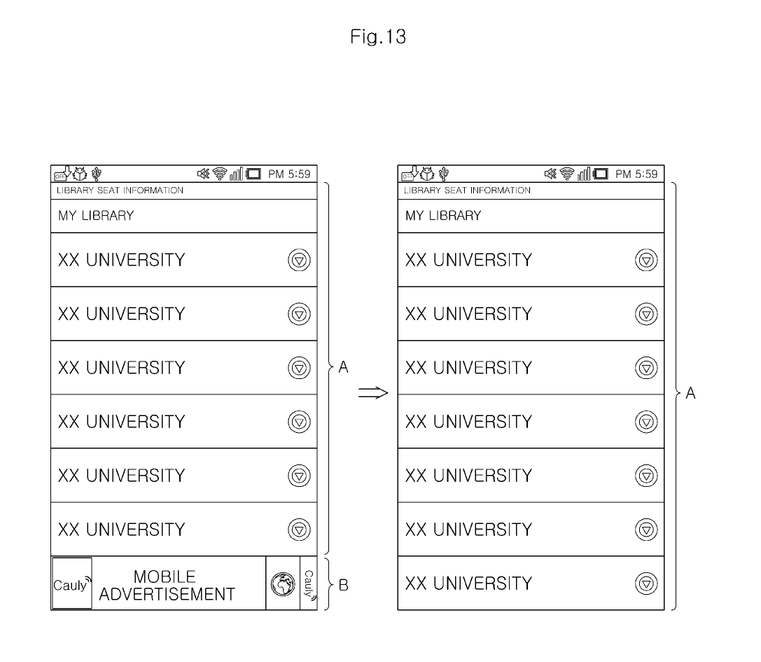

In operation 50, the application program screen excluding the specific layer is displayed. A more detailed description of operation S30 will be described in more detail with reference to FIG. 8. Further, FIG. 8 will be disclosed with respect to FIG. 9, FIG. 10, FIG. 11, FIG. 12, and FIG. 13.

Although the specific layer being overlapped with other layers is described, aspects of the invention are not limited thereto, such that the specific layer may be removed or deleted from the layers configuring the application program screen. Further, the specific layers may be moved to be stored in a portion of the memory, such that a user may choose to view the specific layers separately.

FIG. 8 is a flowchart illustrating an operation of changing a hierarchy of FIG. 7. FIG. 9, FIG. 10, FIG. 11, FIG. 12, and FIG. 13 are views of various layer configurations according to exemplary embodiments of the present invention.

In operation S41, the terminal generates a new layer and arranges the new layer on a reference tier of the hierarchy, such as the lowest layer of the hierarchy as shown in FIG. 9. The lowest layer of the hierarchy may refer to a first tier, which may be disposed first on a display, on which other layers in the hierarchy may be disposed.

In operation S42, the terminal changes the arrangement order of the specific layer and arranges the specific layer to be located at a tier lower than the tier in which the new layer is located within the hierarchy, as shown in FIG. 10.

In operation S43, the terminal selects a valid layer, which may be disposed at the former tier of the specific layer, from among the layers configuring the application program screen as shown in FIG. 11.

The valid layer may correspond to a layer, which may be different and located at a different arrangement location than the specific layer but may have the same arrangement order or located at the same tier as the specific layer before the arrangement order of the specific layer is changed. Further, the valid layer may correspond to a layer located at a tier lower or above the specific layer before the arrangement order or tier of the special layer was changed.

In operation S44, the attributes and/or arrangement order of the valid layer is changed, such that the valid layer is located at the former arrangement order or tier of the specific layer in the hierarchy before the arrangement order was changed in the hierarchy. More specifically, the attributes and/or the tiers of the valid layer may be changed, such that the valid layer is located at the tier in the hierarchy of the specific layer before arrangement order was changed in the hierarchy as shown in FIG. 12.

If the specific layer is determined to be an advertisement layer and the valid layer is an application program layer located at a tier lower than the specific layer before the arrangement order or tier of the specific layer was changed, an advertisement layer B may be removed, hidden, or overlapped by an application layer. More specifically, a part of an application program layer A hidden or overlapped by the advertisement layer B may be displayed in a screen region occupied by the advertisement layer as shown in FIG. 13. Further, since the screen region occupied by the application program layer A is increased by the screen region from which the advertisement layer B is removed, the attributes and/or arrangement order of a layer that may display a scrolling bar or other control mechanism may be changed. The control mechanism may be located at a lower tier among the layers of hierarchy. However, aspects of the invention are not limited thereto, such that the valid layer may be an application program layer located at the same tier or lower tier as the specific layer before the arrangement order or tier of the specific layer was changed. Further, if the valid layer was located at a different tier or the same tier as the specific layer, the valid tier may be adjusted in size to overlap the region formerly disposed by the specific layer.

In operation S50, the terminal displays the application program screen in which the hierarchy is changed.

If it is determined that the specific layer is not present in operation S30, the terminal performs S50 without performing S40.

Referring to FIG. 2 again, a screen display apparatus of a terminal includes a display unit 100, an analysis unit 200, a determination unit 300 and a changing unit 400. The analysis unit 200, the determination unit 300, and the changing unit 400 may be mounted and/or implemented in a controller to control one or more operations of the terminal.

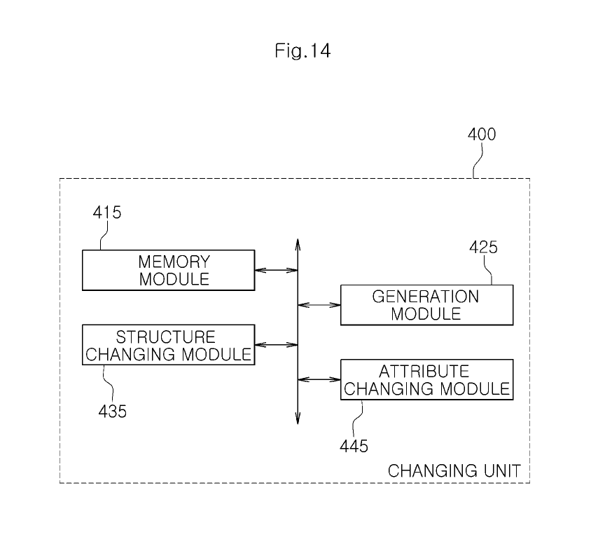

FIG. 14 is a schematic block diagram illustrating a configuration of a changing unit according to an exemplary embodiment of the present invention.

The changing unit 400 may not change the hierarchy of the application program screen if the determination unit 300 determines that the specific layer is not present in the layers configuring the application program screen.

If the determination unit 300 determines that the specific layer is present, the changing unit 400 may change the hierarchy of the application program screen such that the specific layer is not displayed through the display unit 100. Further, when the determination unit 300 determines that the specific layer is present, the changing unit 400 may remove the specific layer such that the specific layer may not be displayed through the display unit 100.

More specifically, if the determination unit 300 determines that the specific layer is present among the layers configuring or included in the application program screen, the changing unit 400 may generate a new layer and arrange the new layer on a reference tier of the hierarchy, such as at the lowest layer of the hierarchy.

The changing unit 400 may change the arrangement order or tier of the specific layer and arrange the specific layer on a reference tier of the hierarchy. Further, the specific layer may be arranged at a tier lower than the new layer in the hierarchy. Accordingly, the new layer may be disposed over at least a portion of the specific layer.

In addition, if the tier of the specific layer is changed in the hierarchy, the changing unit 400 may generate and arrange a replacement layer at the former arrangement order or tier of the specific layer before the arrangement order or tier of the specific layer was changed in the hierarchy.

The replacement layer may include a layer to display a variety of information to provide the terminal with user convenience. For example, the replacement layer may include, without limitation, at least one of a layer for displaying a central processing unit (CPU) usage, resource usage or network usage of the application program currently being executed in the terminal, and a layer to display an application program shortcut input button.

The changing unit 400 may change the attributes of the replacement layer to suit the attributes of the specific layer when the replacement layer is arranged at the former arrangement order or tier of the specific layer before the arrangement order is changed in the hierarchy.

Referring to FIG. 14, the changing unit 400 includes a memory module 415, a generation module 425, a structure changing module 435, and an attribute changing module 445.

The memory module 415 may store attributes of various layers including a new layer, which may occupy some portion or the entire display region of the display unit 100 and a replacement layer, which may occupy the display region of the display unit 100 corresponding to the specific layer. The generation module 425 may generate a new layer and a replacement layer using the attributes of one or more layers stored in the memory module 415. The structure changing module 435 may arrange the new layer and the replacement layer generated by the generation module 425, change the arrangement order or tier of the specific layer, and change the hierarchy of the layers configuring the application program screen. The attribute changing module 445 may change the attributes of the replacement layer generated by the generation module 425.

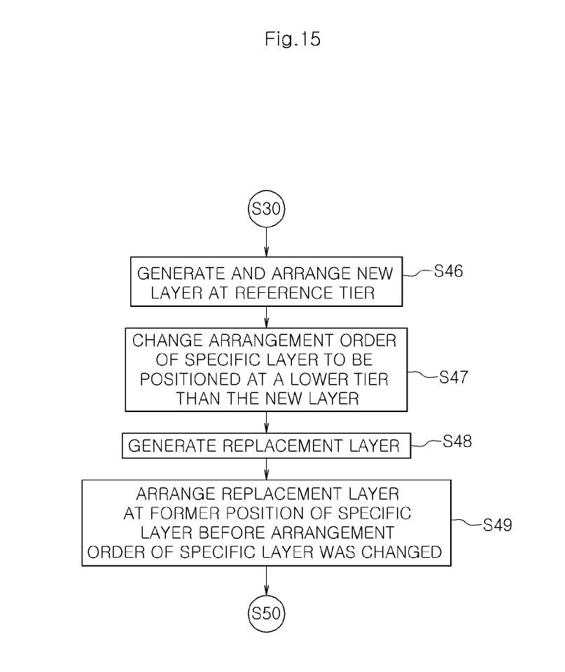

FIG. 15 is a flowchart illustrating an operation of changing a hierarchy according to an exemplary embodiment of the present invention.

Referring to FIG. 7 again, in operation S10, the application program installed in the terminal is executed. In operation S20, the terminal configures the application program screen including one or more layers in association with the application program.

In operation S30, the terminal determines whether the specific layer is present in the layers configuring the application program screen.

In operation S40, the hierarchy of the application program screen is changed such that the specific layer is not displayed on the screen, if the terminal determines that the specific layer is present. Further, the specific layer may be removed such that the specific layer may not be displayed if the terminal determines that the specific layer is present.

Referring to FIG. 15, a more detailed description of the operation S40 is provided. In operation S46, the terminal generates and arranges a new layer on a reference tier of the hierarchy, such as at the lowest tier of the layer hierarchy as shown in FIG. 9.

In operation S47, the terminal changes the arrangement order of the specific layer and arranges the specific layer at a tier that is lower than the tier in which the new layer is disposed in the hierarchy as shown in FIG. 10.

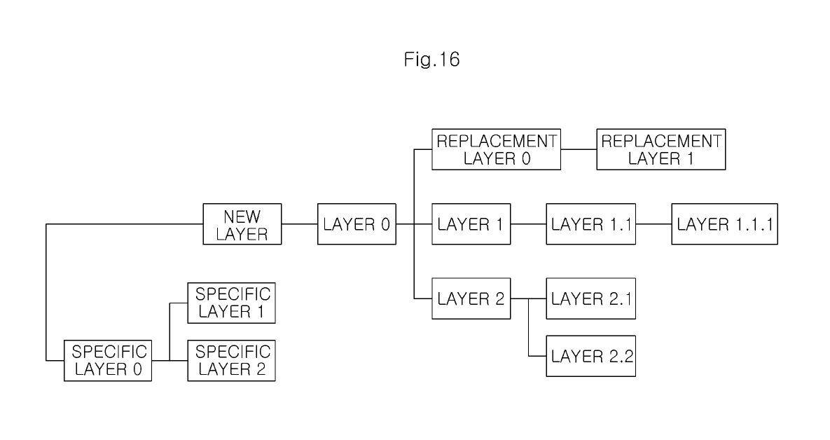

In operation S48, the terminal generates the replacement layer as shown in FIG. 16. In operation S49, the terminal arranges the generated replacement layer at the former arrangement order or tier of the specific layer before the arrangement order or tier of the specific layer was changed in the hierarchy.

When the replacement layer is arranged at the former arrangement order or tier of the specific layer before the arrangement order or tier of the specific layer was changed in the hierarchy in operation S49, the terminal may change one or more attributes of the replacement layer to suit the attributes of the specific layer.

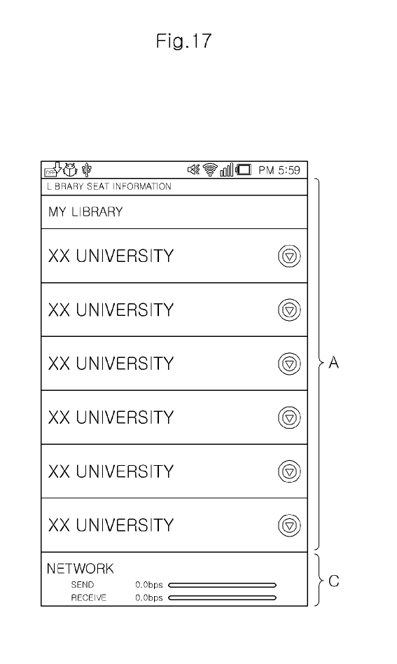

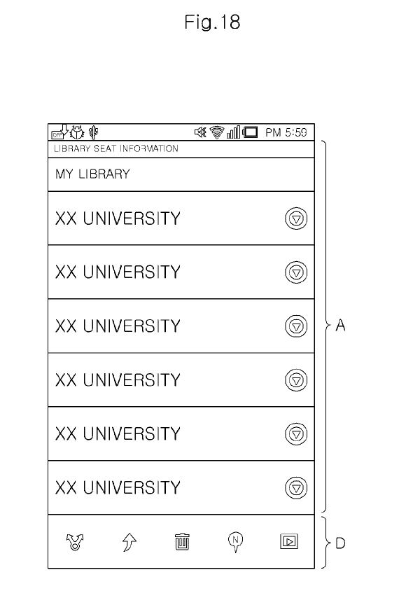

Referring to FIG. 17 and FIG. 18, if the specific layer is an advertisement layer, in operation S46, operation S47, operation S48, and operation S49, a replacement layer, such as a layer C, which may provide a system notification display, such as CPU usage, resource usage or network usage of the application program executed as shown in FIG. 17. Similarly, a layer D, which may display an application program shortcut button or an application program management button as shown in FIG. 18, may be displayed in the screen region occupied by the advertisement layer in the application program screen region. However, aspects of the invention are not limited thereto, such that other control mechanisms, display of information may be utilized at the region that was formerly occupied by the advertisement layer.

In operation S50, the terminal displays the application program screen in which the hierarchy is changed.

Meanwhile, if it is determined that the specific layer is not present in S30, the terminal performs S50 without performing S40.

According to exemplary embodiments of the present invention, by selectively disabling a layer, such as an advertisement layer, among layers configuring an application program screen to be displayed on a screen of a terminal, it may be possible to display a layer to display information that may be more useful to a user in a screen region of the terminal, which is occupied by the layer that may not be desired, or display a layer to display a layer hidden by the layer that may not be desired. Thus, it may be possible to more efficiently utilize the screen region of the terminal.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a display unit to display a plurality of layers associated with an application program;
an analysis unit to determine a hierarchy of the layers;
a determination unit to determine whether a specific layer is included in the layers; and
a changing unit to change a tier of the specific layer in the hierarchy of layers from a first tier to a second tier.

2. The terminal of claim 1, wherein the second tier is the lowest tier among the hierarchy of the layers.

3. The terminal of claim 1, wherein the changing unit generates a new layer if the specific layer is included in the layers and arranges the new layer at a tier above the specific layer.

4. The terminal of claim 1, wherein the changing unit selects a valid layer at a third tier among the layers and arranges the valid layer at the first tier.

5. The terminal of claim 1, wherein the specific layer is associated with an advertisement.

6. The terminal of claim 4, wherein the valid layer is associated with the application program.

7. The terminal of claim 1, wherein the changing unit generates a replacement layer and arranges the replacement layer at the first tier.

8. The terminal of claim 4, wherein the replacement layer is associated with a system notification display.

9. The terminal of claim 1, wherein one or more layers comprises at least one of identification information, arrangement order information, and attribute information.

10. A method for selectively displaying a screen on a terminal, comprising:
displaying an application program screen comprising a plurality of layers;
determining a hierarchy of the layers;
determining whether a specific layer is included in the layers; and
changing a tier of the specific layer in the hierarchy of layers from a first tier to a second tier.

11. The method of claim 10, wherein the second tier is the lowest tier among the hierarchy of the layers.

12. The method of claim 10, further comprising:
generating a new layer if the specific layer is included in the layers; and
arranging the new layer at a tier above the specific layer.

13. The method of claim 10, further comprising:
selecting a valid layer at a third tier among the layers; and
arranging the valid layer at the first tier.

14. The method of claim 10, wherein the specific layer is associated with an advertisement.

15. The method of claim 13, wherein the valid layer is associated with the application program.

16. The method of claim 10, further comprising:
generating a replacement layer; and
arranging the replacement layer at the first tier.

17. The method of claim 16, wherein the replacement layer is associated with controlling a display of the application program screen.

18. The method of claim 16, wherein the replacement layer is associated with a system notification display.

19. The method of claim 10, wherein one or more layers comprises at least one of identification information, arrangement order information, and attribute information.

20. A method for selectively displaying a screen on a terminal, comprising:
displaying an application program screen comprising a plurality of layers;
determining a hierarchy of the layers;
determining whether a specific layer is included in the layers; and
changing a tier of the specific layer to a reference tier to display the layers over the specific layer for hiding a display of the specific layer.
